(19) United States
(12) Patent Application Publication
(10) Pub. No.: US 2011/0101789 A1
(43) Pub. Date: May 5, 2011

(54) RF POWER HARVESTING CIRCUIT

(76) Inventors: Thomas Steven Salter, JR., Ellicott City, MD (US); George M. Metze, Millersville, MD (US); Neil Goldsman, Takoma Park, MD (US); Kwangsik Choi, College Park, MD (US); Yves Ngu, Essex, VT (US); Zeynep Dilli, Hyattsville, MD (US); Martin Peckerar, Silverspring, MD (US); Li Bo, College Park, MD (US)

(21) Appl. No.: 12/628,585

(22) Filed: Dec. 1, 2009

Related U.S. Application Data
(60) Provisional application No. 61/118,808, filed on Dec. 1, 2008.
(60) Provisional application No. 61/119,848, filed on Dec. 4, 2008.

(51) Int. Cl. H01F 38/14

(52) U.S. Cl. 307/104

(57) ABSTRACT

Provided is an RF power harvesting circuit with improved sensitivity to RF energy. The RF power harvesting device includes an inductor, a first capacitor connected to the inductor, a first MOSFET connected to a first node, and a second MOSFET connected to the first node. The inductor or the first capacitor are connected to the first node.

### CROSS-REFERENCE TO RELATED PATENT APPLICATION

This application claims priority from U.S. Provisional Application No. 61/118,808 filed on Dec. 1, 2008, and U.S. Provisional Application No. 61/119,848 filed on Dec. 4, 2008, the disclosures of which are incorporated herein by reference in their entirety.

### STATEMENT REGARDING FEDERALLY SPONSORED R&D

This invention was made with support under H9823004C0490 awarded by the National Security Agency. The government has certain rights in the invention.

### BACKGROUND

1. Technical Field

The present invention relates to an RF power harvesting circuit design, and more particularly, to an RF power harvesting circuit design which efficiently harvests power from RF energy.

2. Description of the Related Art

Electronic devices are ubiquitous throughout the world today, with immeasurable applications and devices permeating all aspects of society. Energy that would have been wasted by such devices can now be recycled. For example, in some related art electronic devices (e.g., a mobile device) that generate radio frequency (RF), the RF is harvested back into the electronic device. All electronic devices require power to operate. Ambient energy in any form is an attractive source of power, particularly as power becomes more costly, or in areas where it is scarce. Ambient energy is also desirable where there is a need for electronic devices to operate for longer times between connection to readily available sources of power, or when there is a need to remotely recharge electronic devices, or to improve the overall efficiency of electronic devices. Of course, instead of scavenging for the ambient RF energy, intentional beaming of RF energy to a target device is also possible.

In this context, radio frequency (RF) energy represents an attractive source of power. Many electronic devices (e.g., communications devices) emit RF energy. For example, indoor power densities greater than 0.5 uW/cm² can be detected even a kilometer away from an FM radio tower. Comparable power densities can be detected at higher frequencies both domestically and internationally including GSM and ISM bands. Harvesting this energy from the environment can provide many benefits to electronic circuit and device designers. These benefits include, but are not limited to, extending operational life of electronic devices, providing new benefits such as remote recharging, reducing size of the electronic devices, and improving overall device efficiency.

RF power harvesting devices/RF energy scavenging devices have been constructed to capture this energy. An example of a related art power harvesting circuit is shown in FIG. 1. FIG. 1 illustrates the basic Villard voltage doubler circuit. An intuitive understanding of this circuit can be gained by first examining what occurs when current flows in the direction of I₁. The diode D₂ blocks the flow of current through the capacitor C₂.

Therefore, all of the current goes across the capacitor C₁. This charges the capacitor C₁ up to roughly the same level as the peak of the AC voltage. Once the up-swing of the AC cycle (I₂) has been reached, the diode D₁ turns off, the diode D₂ turns on, and the voltage across both the AC source and C₁ drops across the capacitor C₂, charging it to approximately twice the peak voltage of the AC signal.

The related art RF scavenging circuits, however, require a minimum or threshold amount of incident RF energy to “turn on” and begin providing useful energy to other circuits and devices. Such devices can be devices that immediately perform a function or energy storage devices such as batteries and capacitors. Incident energy that falls below the minimum threshold is not captured, thereby reducing the efficiency and effectiveness of the scavenging circuit. Thus, there is a need for an RF power harvesting device that can capture and utilize ambient energy that falls below the minimum threshold for turning on the device.

### SUMMARY

Embodiments of the disclosed RF energy harvesting circuit improve the sensitivity of RF energy harvesting circuits over the related art power harvesting circuits.

According to an aspect of the present invention, there is provided an RF power harvesting device including an inductor, a first capacitor connected to the inductor, a first MOSFET connected to a first node, and a second MOSFET connected to the first node, and the inductor or the first capacitor are connected to the first node.

In the RF power harvesting device, values of the first MOSFET and the second MOSFET are such that intrinsic capacitances of the first MOSFET and the second MOSFET and the inductor constitute a substantially resonant circuit during operation of the RF power harvesting device.

The RF power harvesting device of claim 1 further includes a second capacitor connected to a second node, and the second MOSFET is connected to the second node, wherein the second MOSFET is a PMOSFET.

The RF power harvesting device further includes a receiver which detects and receives ambient RF energy, and the first capacitor and the receiver are connected at a third node, the first capacitor and the inductor are connected in series at a fourth node, and the inductor is connected to the first node.

The RF power harvesting device further includes a first set of resisting elements connected to a first gate of the first MOSFET to apply a first DC bias to the first gate, and a second set of resisting elements connected to a second gate of the second MOSFET to apply a second DC bias to the second gate.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a single stage of a related art Villard voltage doubler circuit.

FIG. 2. illustrates a power harvesting device, according to an exemplary embodiment of the present invention.

FIG. 3 illustrates a power harvesting device, according to an exemplary embodiment of the present invention.

FIGS. 4(a)-(b) illustrate different placements of a matching inductor and a DC blocking capacitor and the associated lossy parasitic capacitance and resistance, according to an exemplary embodiment of the present invention.

FIG. 5 illustrates a layout of a power harvesting device, according to an exemplary embodiment of the present invention.

FIG. 6 illustrates a power harvesting device, according to an exemplary embodiment of the present invention.

FIG. 7 illustrates biasing the gate of diode-connected MOSFETs, according to an exemplary embodiment of the present invention.

FIG. 8 illustrates a circuit design implementing sacrificial current biasing, according to an exemplary embodiment of the present invention.

FIG. 9 illustrates an ideal diode response of a diode connected MOSFET with regular FETs and a diode connected MOSFET using low threshold voltage FETs.

FIG. 10 shows a power harvesting device, according to an exemplary embodiment of the present invention.

FIG. 11 illustrates the layout of RF harvesting circuits to form a silicon integrated circuit, the layout including five RF power harvesting circuits, which are the physical implementations of the harvesting circuits shown in the circuit schematics shown in other figures, according to an exemplary embodiment of the present invention.

FIG. 12 illustrates a comparison of measured RF to DC conversion efficiency versus output voltage between a power harvesting device with sacrificial biasing, and a power harvesting device without biasing.

FIG. 13 illustrates a self-powered system.

FIGS. 14(a)-(b) illustrate different types of batteries implemented in the system shown in FIG. 13.

FIG. 15 illustrates a schematic of a switched capacitor DC-DC converter.

FIG. 16 illustrates a three stage converter operation for 0.35V input at 20 Hz switching using 100 uF external capacitors.

FIG. 17 illustrates the frequency dependency of a 1000 uF capacitor charging with 0.35V input and three 100 uF external storing capacitors.

FIG. 18 illustrates the discharging test results for 60 hour charging (1 KΩ) load, 0.2 Hz clock signal) with a rigid battery.

FIG. 19 illustrates the discharging test results for 4 hour charging (1 KΩ load, 25 Hz clock signal) using two chips with a rigid battery.

FIG. 20 illustrates a switching signal generated by a ring counter using four flip-flops.

FIG. 21 illustrates four converter charging results—(a) Vin=0.35V for a rigid battery, (b) Vin=0.4V for a rigid battery, (c) Vin=0.45V for a rigid battery, and (d) Vin=0.45V for a flexible battery.

### DETAILED DESCRIPTION OF EXEMPLARY EMBODIMENTS

The present invention will now be described more fully with reference to the accompanying drawings, in which exemplary embodiments of the invention are shown.

One embodiment of the present invention provides a modified power matched Villard voltage doubler circuit, compatible with modern complementary metal-oxide-semiconductor (CMOS) processes, which demonstrates the ability to harvest RF electromagnetic energy that is available at power levels as low as in the microwatt range. Revisions to the Villard voltage doubler have been made and accessory circuitry has been added to provide it with the ability to harvest energy from power levels as extremely low as tens of μWatts (micro) low power levels. In the related art, relatively large values of input power of hundreds of μWatts or even higher are required to utilize a Villard voltage doubler topology. The reason for this it that the general Villard voltage doubler topology utilizes rectifying diodes which need to be turned on in order to transform AC currents and voltages into DC currents and voltages, so that their intrinsic energy can be stored. However, turning on these diodes requires several tenths of a volt, and a relatively large amount of input power is typically required to generate these voltages.

The present invention provides several modifications to the Villard voltage doubler topology, which modifications allow it to harvest energy from very low power levels and go beyond the limitation previously set by the threshold level of the rectifying diodes. For instance, one embodiment of the present invention provides resonant reactive elements are incorporated in a CMOS circuit that allows for the generation of relatively large voltages, without the need for large power, in order to turn on the rectifying diodes. The Villard circuit topology is implemented in an actual CMOS process making it realizable for fabrication as an integrated circuit in modern technology. Certain parasitic elements of the CMOS process are utilized to increase voltage levels and improve circuit performance (typically, parasitic elements limit circuit performance).

Application specific circuit layout designs are disclosed so that the effect of other parasitic elements would be minimized. Diode connected CMOS devices are used instead of standard diodes to implement the Villard topology. Furthermore, in one embodiment, instead of using an n-type metal-oxide-semiconductor field-effect transistor (NMOSFET), one of the diode functions is implemented using a p-type MOSFET (PMOSFET) polarity. This embodiment mostly eliminates the body effect and allows for the diode connected MOSFETs to be turned on at a lower voltage, thereby giving rise to a lower threshold power in order to obtain AC to DC conversion and allow for energy storage at lower power levels. In another embodiment, a set of sacrificial bias resistors is used to increase the gate voltage of the MOSFETs, and thereby turn them on at a lower voltage which allows for further sensitivity and increases energy harvesting. In addition, in yet another embodiment, circuit blocks are stacked in series to generate even high DC voltage levels from microwatt levels of electromagnetic RF energy.

It is desirable to integrate the power harvesting circuits of the disclosed embodiments onto CMOS integrated circuits. To accomplish this, the diodes can be replaced with diode connected MOSFETS M1 and M2, as illustrated in FIG. 2. This modification has an advantage in that it can be naturally fabricated using a CMOS process. Furthermore, using diode connected MOSFETs gives added flexibility for establishing an adjustable effective diode turn on voltage.

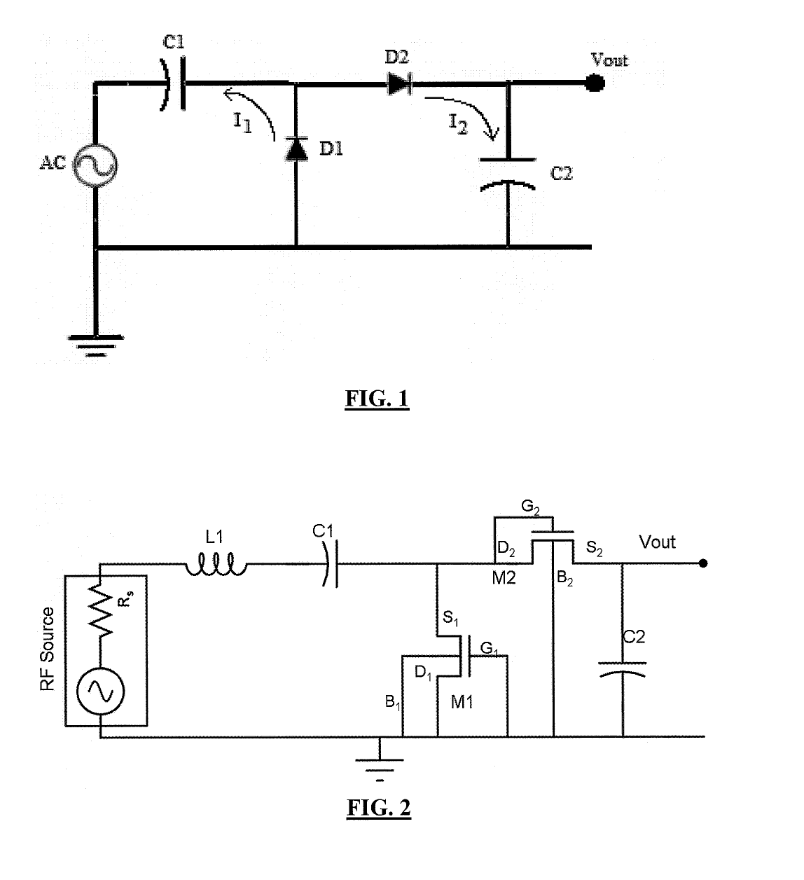

An inductor L1 can be added near the input power source (RF source) as shown in FIG. 2. This helps give rise to a matching circuit. In addition to the standard concept of matching, which allows for maximum power transfer from a fixed source impedance, the inductor works in concert with the parasitic intrinsic capacitances usually associated with a MOSFET gate to generate a very large voltage across the reactive components (discussed below in further detail). The generation of such a large voltage is one advantage of using the power harvesting circuit shown in FIG. 1. Specifically, the generation of the large voltage facilitates the turning on of the CMOS diode connected devices at low incident power levels in order to achieve efficient AC to DC conversion, and ultimately energy storage. Thus, instead of the parasitic intrinsic capacitances functioning to reduce the frequency response and be detrimental to CMOS circuit performance, their reactive nature when working in concordance with the added input inductor L1 allows for generation of large voltages which will ultimately make the power harvesting device more sensitive to harvesting RF energy. This circuit has a complex impedance that mainly consists mainly of a reactive part.

A. Modification to Matching Inductor and use of Intrinsic Capacitance for Large Voltage Generation and Diode Turn-On.

As mentioned previously, in order to be able to utilize the Villard voltage doubler topology, it is necessary to achieve voltages sufficiently large to turn on the diodes (or diode connected MOSFETs) D1 and D2. However, this is difficult if the power of the input signal is very low, in the microwatt range, for example. To overcome this problem, reactive components are utilized in the design which are able to accumulate relatively large amounts of AC power over time, and thus generate voltages that are sufficiently large to turn on the diodes, and thus harvest RF energy even at power levels as low as microwatts.

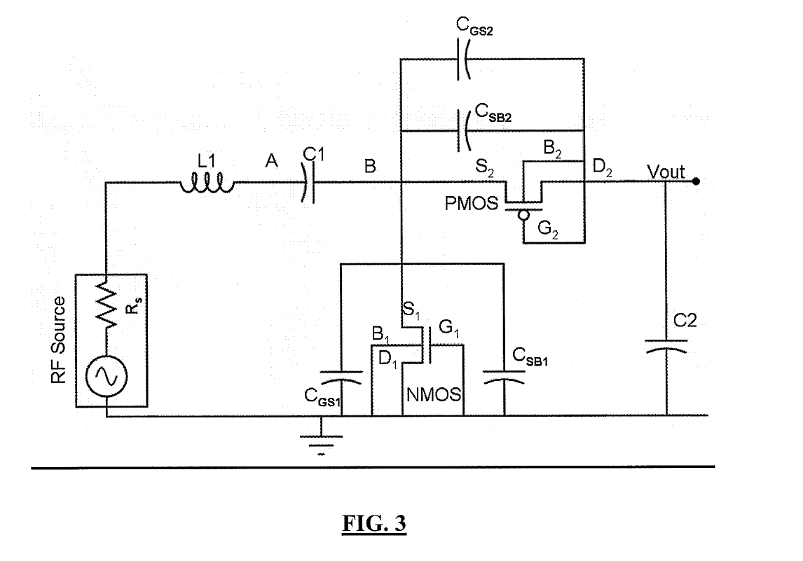

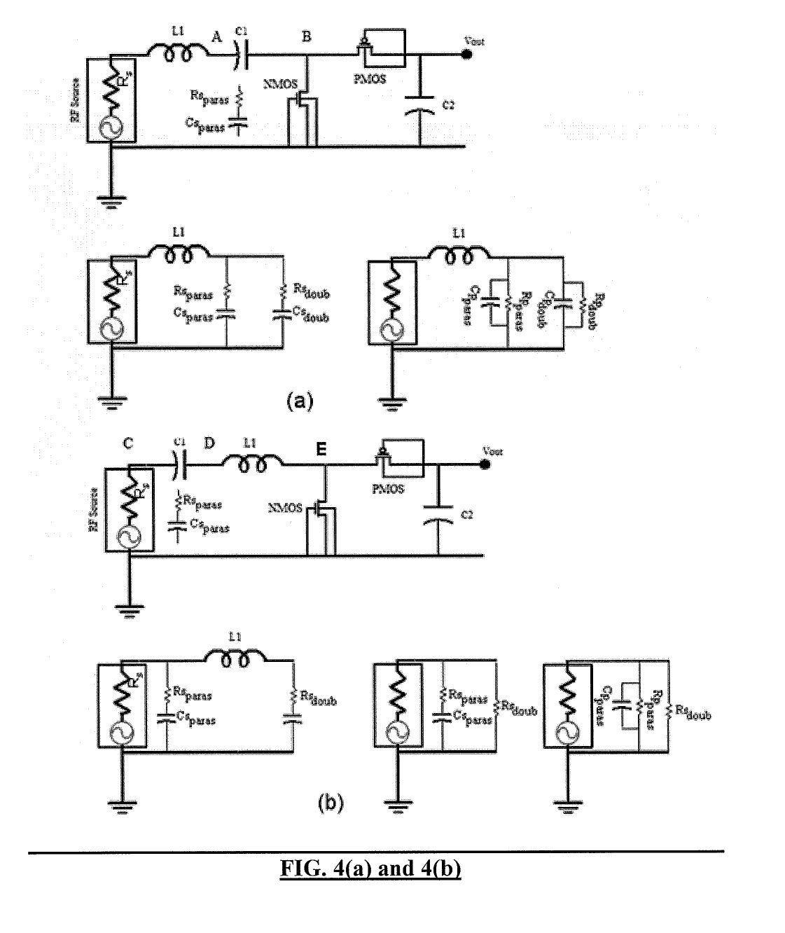

The reactive elements that generate the large voltages for turn on are shown in FIG. 3 (e.g., the inductor L1, and the intrinsic MOSFET capacitors C_{GS1}, C_{SB1}, C_{GS2}, and C_{SB2}). The inductor L1 is used to resonate with the capacitive structures intrinsic to the MOSFETs themselves and the fabrication process. The inductor L1 is an accessory element constructed on the chip. However, instead of adding an accessory capacitor network to generate the complementary reactive impedance, the capacitors that are typically deemed as parasitic and detrimental to circuit performance are utilized in the current embodiment. More specifically, the intrinsic source-gate capacitance (C_{GS1}, C_{GS2}), and the source-body capacitance (C_{SB1}, C_{SB2}) associated with the two diode connected MOSFETS (M1 and M2), are used.

From FIG. 3, it can be seen that that accessory inductor L1 and the intrinsic capacitors C_{GS1}, C_{SB1}, C_{GS2}, and C_{SB2} together form a series resonant circuit. The values of these intrinsic capacitors are in the Femto-Farad range. Furthermore, the capacitors C1 and C2 are orders of magnitude larger than the aforementioned CMOS intrinsic capacitors, and thus have negligible impedance at the frequencies of interest (hundreds of MHz to GHz). As such, impedances of the capacitors C1 and C1 can be neglected. Considering the relative magnitudes of the intrinsic capacitors with respect to C1 and C2, the intrinsic capacitors can be considered to be at AC ground. Since this is the case, the intrinsic capacitors are in parallel with the gate-source junction of the diode connected MOSFETs. Thus, when large voltages are generated across the capacitive reactive elements, large voltages are also generated across the gate-source voltages (V_{GS}) of the MOSFETs, thereby turning them on and allowing them to operate as rectifiers.

The optimal response of the circuit is obtained at an input frequency where the accessory matching circuit (comprising of L1 and the intrinsic capacitors) is in resonance. This condition maximizes the voltage at the input (point B in FIG. 3) of the circuit, and matches the source impedance of an attached antenna (or any power source) to the complex conjugate of the input impedance of the circuit. Assuming the input power source (i.e., the RF source) has a real source impedance, it can be derived that as long as the following expression (1) is true then the voltage at the input is maximized when the complex impedance (Z_{load}) at the input is matched to the source impedance Rs in FIG. 3 (Rsource in expression 1).

$$\sqrt{\frac{\vert {Z}_{load} \vert}{{R}_{source} cos ( φ )}} > 2 \qquad ( 1 )$$

In expression 1, φ is the phase difference between the voltage and current wave form. This is equivalent to the phase difference between the real and imaginary components of the load impedance.

While achieving resonance is optimal for performance, the power harvesting circuit also performs well even when not at resonance. This is because, even at frequencies that are as much as 20% away from resonance, large voltages are still generated across the reactive components, specifically the intrinsic capacitors. These voltages are also in parallel with the gate-source voltage (V_{GS}) of the diode connected MOSFETs, thereby turning them on and allowing for energy harvesting even at power levels in the microwatt range.

B. Performance Improvement with Parasitic Aware Circuit Layout

While a schematic diagram of an electronic circuit is an abstraction, once that circuit is constructed into a silicon chip the performance of the current changes. One reason for this is that the physical implementation of passive structures, including inductors, capacitors and interconnects, gives rise to unintentional or parasitic elements. For example, laying out of an on-chip inductor gives rise to unintentional capacitors from the inductor to the substrate ground.

In one embodiment of the disclosed power harvesting device, performance enhancement can be achieved by switching the order of the impedance matching inductor L1 and the DC blocking capacitor C1, as illustrated in FIG. 4b. While theoretically the schematic shown in FIG. 3 is independent of the order of the L1-C1 pair, it becomes apparent after examination of the parasitics incurred during layout, that the schematics in FIG. 3 (also see FIGS. 4a) and 4b are different. The schematic produced by the layout shown in FIG. 4b is less sensitive to the negative parasitics associated with the capacitor C1.

In particular, the impedance to voltage doubler at point A in FIG. 3 is dominated by the intrinsic capacitances of the diode connected MOSFETs (C_{GS1}, C_{SB1}, C_{GS2} and C_{SB2}). Therefore, it appears as a short at the RF frequency and the impedance at point B is also highly reactive. The parasitic capacitance of C1 results in an imaginary impedance parallel to the input impedance at point A and B. This imaginary impedance serves to reduce the magnitude of the complex impedance and reduce the phase difference between the imaginary and real part of the complex input impedance. It can be seen from the expression (2) below that this will reduce the magnitude of the voltage at the input to the voltage doubler.

$$\vert {V}_{load} \vert = \frac{{V}_{source}}{2} \sqrt{\frac{\vert {Z}_{load} \vert}{{R}_{source} cos ( φ )}} \qquad ( 2 )$$

By switching the order of the capacitor C1 and the inductor L1, as in FIG. 4b, the reactive part of the impedance at points D and E is tuned out generating a large resonant voltage across the MOSFET capacitors, resulting in a real impedance on the order of 10 to 100 ohms. This is orders of magnitude lower than any parasitic impedance to the substrate due to C1. Therefore, the circuit in FIG. 4b shows superior performance to the circuit in FIGS. 3 and 4a in the presence of parasitic capacitances from C1.

This improvement can also be understood as follows. If one considers the operation of the resonant voltage generator circuit, one realizes that the largest voltages are generated at point B and the lowest voltage exist at the node connecting inductor L1 and the source resistor Rs in FIG. 3. Therefore, in the current embodiment, the parasitic capacitor and parasitic series resistor are moved away from the highest potential in the circuit to the lowest potential in the power harvesting circuit by switching the order of the inductor L1 and the capacitor C1. While this has no effect on the theoretical operation of the circuit with respect to a schematic (done without regard to actual layout and fabrication), it greatly improves actual operation by placing the parasitic elements at a lower voltage where they will draw substantially less current, and thereby minimize their negative impact on power harvesting circuit's operation.

Another implementation of this concept is performed with the layout of inductor L1. The inductor L1 is implemented on two metal layers of the CMOS process. The lower layer, which is closer to the substrate, gives rise to larger parasitic capacitance and substrate resistance. Therefore, the inductor L1 is fabricated with the lower layer location placed at the location where the circuit voltage is lowest. This location is the side of inductor L1 that is closer to the input and specified by point D in FIG. 4b.

It should also be noted that modern processes such as the IBM 8 RF process require that a certain ratio of gate tiedowns to metal area be maintained. Connecting the inductor L1 directly to the gate of NMOS 2 (e.g., M2 in FIG. 2) in a Villard voltage doubler would require an unrealistic number of tiedown contacts. Therefore, this technique is best suited for designs that use a PMOS in place of NMOS 2 as discussed below.

C. Use of PMOS to Reduce Body Effect

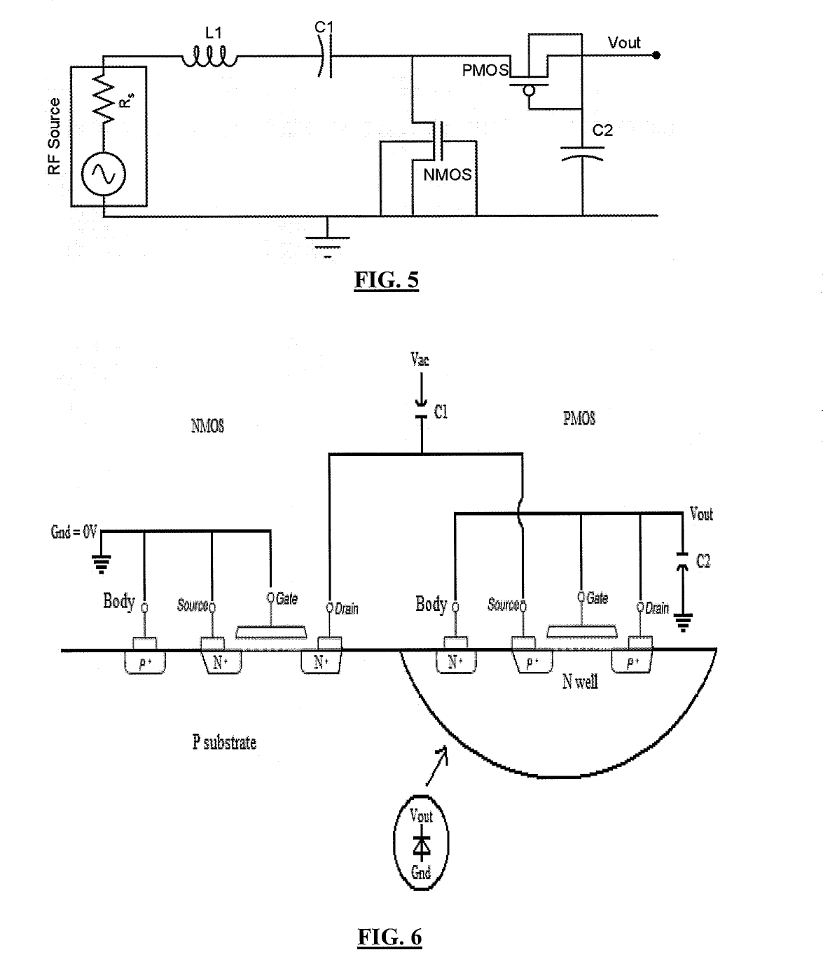

FIG. 5 illustrates a power harvesting circuit with an NMOSFET (e.g., M2 in FIG. 2) replaced with a PMOSFET (PMOS in FIG. 5). In a steady state, an NMOS 2 (e.g., M in FIG. 2) will have a source potential that is significantly higher than the body potential. This gives rise to an increase in the threshold voltage of NMOS 2 through the body effect. This causes the diode connected NMOS 2 to turn on at a higher voltage, thereby reducing efficiency. To minimize the body effect in the current embodiment, NMOS 2 is replaced with a diode connected PMOS, as shown in FIGS. 3 and 5. The PMOS has the body, gate, and drain node connected to Vout and the source node connected to the voltage at the source terminal of the diode connected NMOS 1. The body effect of NMOS 1 (e.g., M1 in FIG. 2) is already minimized and is treated similar to M1 in FIG. 2. The PMOS only conducts when the gate voltage is below the source voltage. Since the gate has been connected to Vout, this occurs when the AC voltage at the input is positive with respect to ground. Since both the body and the source of the PMOS are connected to Vout, no threshold voltage increase occurs due to the body effect. This improvement can be combined with the other embodiments discussed above, including the embodiment shown in FIG. 3 where the order of the capacitor C1 and the inductor L1 are transposed to reduce parasitic capacitive and resistive losses.

In order for the design to work, the PMOS needs to be sufficiently isolated to allow connecting the body of the PMOS to Vout without any current flowing from the PMOS body to the bulk substrate. Connecting the body of a diode connected PMOS to Vout is possible due to the fact that PMOS FETs are placed in an n doped well inside of the p substrate.

As seen in FIG. 6, the PMOS is built in an N well. Since the junction from the N well to the P substrate acts as a diode, if the voltage potential in the N well is higher than the voltage potential in the P substrate, current will not flow. This is what allows the body to be connected to Vout which is higher than the potential of the substrate. The junction capacitance between the N well and the substrate is parallel to and several orders of magnitude lower than the output capacitance C2 of the power harvesting circuit. Therefore, the junction capacitance has no significant effect on the circuit performance.

D. Sacrificial Biasing

The output voltage of the related art voltage doubler is two times the input voltage minus the threshold voltage of both diodes. Therefore, minimizing the threshold voltage of the diodes maximizes the voltage at the output of the voltage doubler. Previous works in the related art have attempted to improve RF power harvesting efficiency by using special MOSFETS with reduced gate threshold voltages.

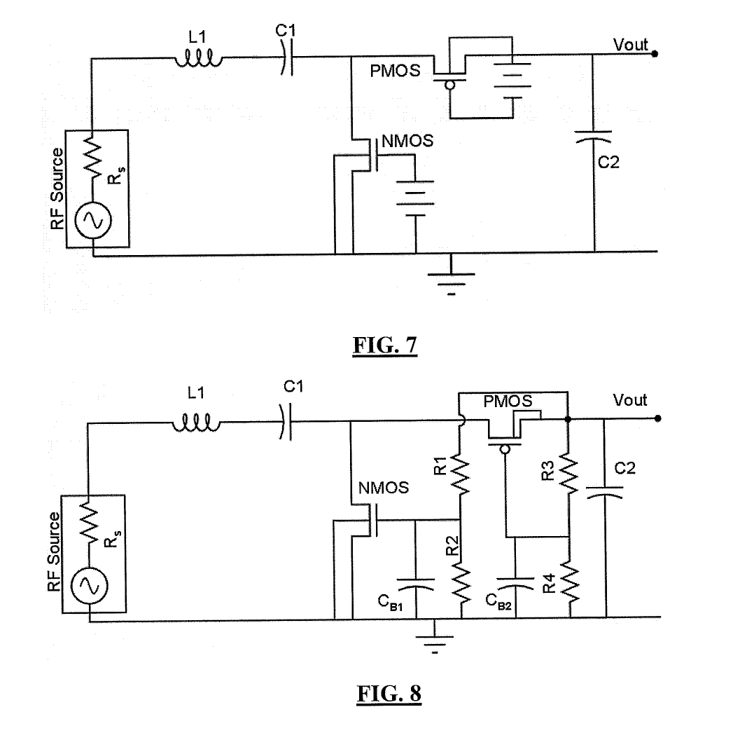

In an exemplary embodiment of the present invention shown in FIGS. 7 and 8, an alternative technique uses biasing at the gate combined with the use of a PMOS in place of the output NMOSFET to eliminate the threshold voltage for both diode connected MOSFETs.

For example, in the embodiment shown in FIG. 7, voltage sources are directly connected to the gates of the diode connected MOSFETs in the RF power harvesting circuit.. An alternative approach is to use the desired output voltage to create the bias voltages through a voltage divider network, as shown in FIG. 8. This technique sacrifices some current to create an overall improvement to system efficiency. In this embodiment, the NMOS 2 is replaced by a PMOS IN FIG. 8 for two reasons. First, the threshold voltage of the output diode connected MOSFET must be below Vout to be obtainable through a voltage divider network. Second, the gate is connected to a DC node in the circuit. Sufficiently larger resistors R1, R2, R3, and R4 are used in the divider network IN FIG. 8 to reduce power dissipated due to the bias current. The resistors are chosen to be 1 MΩ to 10 MΩ for 10 μW input power. Generally, the smaller the input power, the higher the resistances. This power dissipation can be designed to be orders or magnitude below the increase in output power due to the bias voltages. Practical limitations are placed on the size of the resistors used in the divider network due to a physical limitation of the resistor size in the circuit layout.

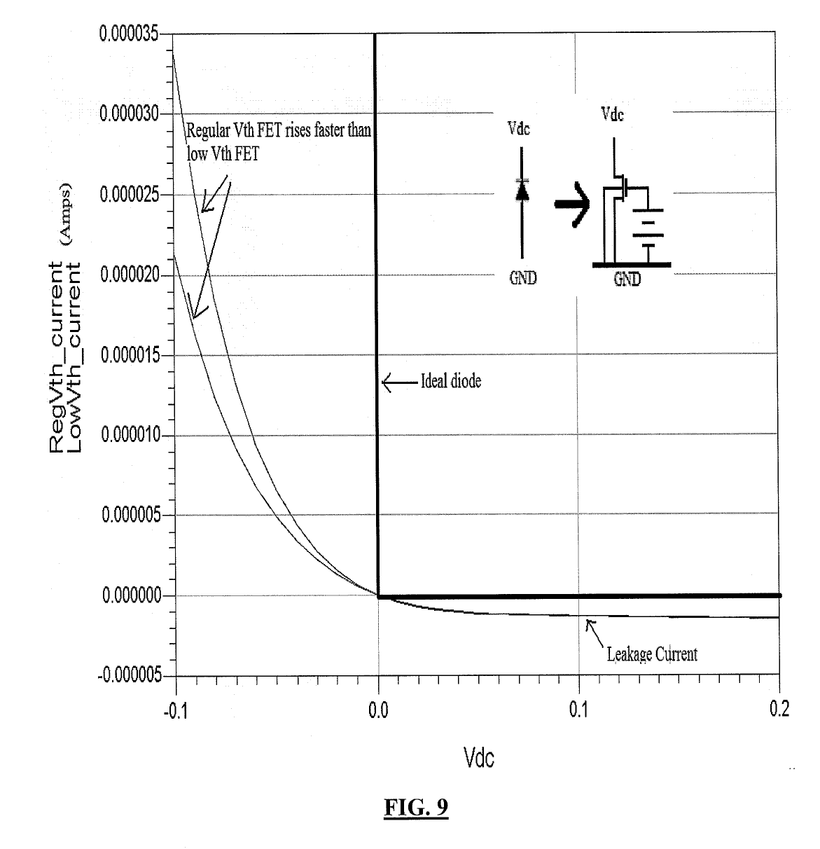

In the current embodiment, traditional MOSFETs outperform low threshold voltage MOSFETs when sacrificial current biasing is utilized. This is in contrast to related art literature that has concluded that the use of low threshold voltage MOSFETs provides the best performance for RF power harvesting. So, instead of using low threshold voltage MOSFETs, we have introduced sacrificial biasing while using regular MOSFETs and have achieved improved results. The improvement is because we achieve the effect of easily turning on the MOSFETs, while retaining the improved performance of regular MOSFETs with respect to the turn on characteristics as shown in FIG. 9. Regular MOSFETs, have a sharper turn-on transition than low threshold voltage MOSFETs resulting in a faster turn on when transitioning to the open state, showing better RF conversion efficiency.

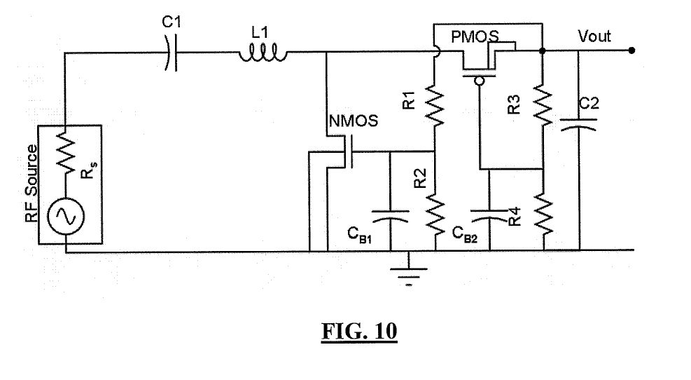

FIG. 10 illustrates a comprehensive design of a power harvesting device which includes the transposition of the inductor L1 and the capacitor C1 of FIG. 4b, the implementation of the PMOS device in place of M2 as shown in FIG. 5, inclusion of sacrificial bias resistors R1-R4 as shown in FIG. 8, as well as implicit utilization of MOSFET intrinsic capacitors for achieving maximum turn on voltages with low power input as shown in FIG. 3.

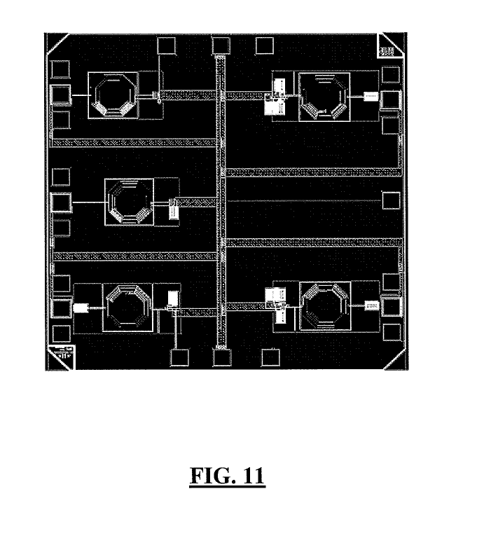

FIG. 11 is the layout of the harvesters to form a silicon integrated circuit. The layout shows five RF power harvesting circuits, which are the physical implementations of the harvesting circuits shown in the circuit schematics shown in other figures. The circuits have been used to compare and test the various designs of the energy harvester. The testing provided the data that has lead to the conclusion and claims in this patent application.

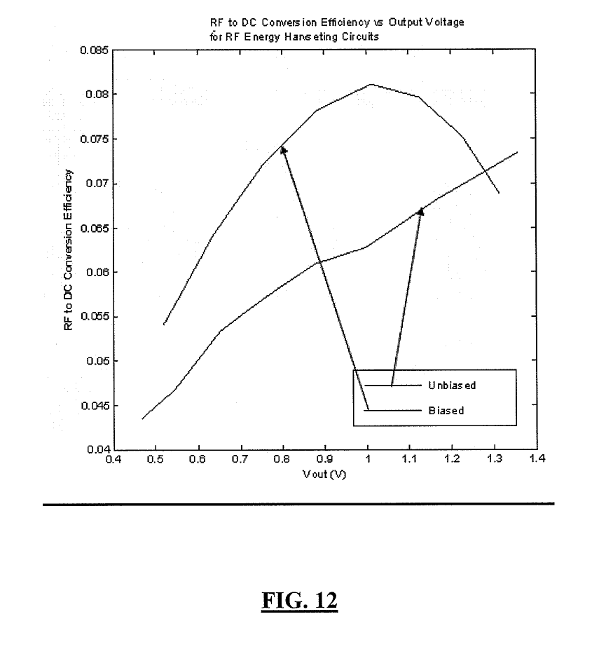

FIG. 12 illustrates a comparison of measured RF to DC conversion efficiency versus output voltage between a power harvesting device with sacrificial biasing, and a power harvesting device without biasing. The harvester with sacrificial biasing achieves high efficiency compared with unbiased design for 1V output voltage. The higher curve represents a higher conversion efficiency for RF energy into DC energy. That is, the results show that for the given output voltages, the sacrificial biasing provides improved efficiency over the unbiased design.

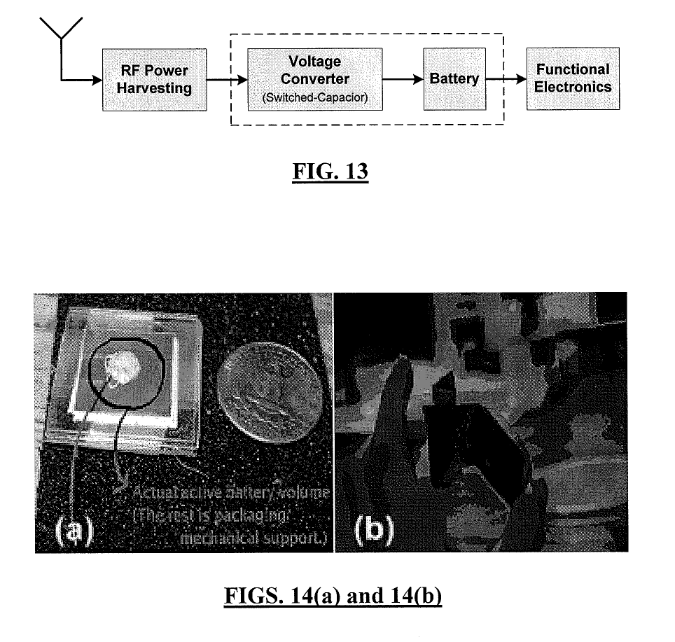

FIGS. 13-21 relate to self-powered systems. An RF power harvesting device discussed with respect to the above embodiments is incorporated. Available RF power is sometimes very weak, so it is not easy to generate a sufficient output for direct use. Using a combination block, converter, and battery provides an attractive solution.

FIG. 13 shows a block diagram of self-powered system including an RF power harvesting block 1, a voltage converter 2, a battery 3, a combined block 4, and functional electronics 5. Here, the RF power harvesting block 1 could be one of the RF power harvesting devices discussed in the above embodiments.

In one embodiment, the converter 2 is a switched-capacitor DC-DC voltage converter. The converter is designed to generate maximum six times of input voltage at output using external capacitors. Through capacitor charging tests, it shows up to 40.5% energy transfer efficiency using 0.35V input for a 1000 uF capacitor charging to 1.4V during 10 minute with a three stage converter. The battery 3 can be a rigid type battery or a flexible type battery. Both types of batteries are successfully recharged using the converter 2. In one embodiment, two hour charging with four parallel converters recharges a rigid battery fully with 0.4V input, so it returns the battery potential to the initial condition before discharging of a 9.85 KΩ load resistor during 10 minutes.

The rigid type electrochemical battery comprises hydrated Ruthenium Oxide (RuO₂.xH₂O) and activated Carbon (CA). These cells have high current capacity, rechargeability, and even flexibility. One of the targets of the battery 3 is playing a role of the power source for distributed sensor networks, or Smart-dust nodes, for achieving a stand-alone system. Much research in the related art has been focused on implementing self-powered systems such as a node of low-power ad hoc distributed networks using an RF power harvesting device. However, when the input power at RF harvesting block 1 is very small, the output is not enough to drive a system or node (e.g., the functional electronics 5). This problem can be solved by using a voltage converter 2 and rechargeable battery 3 combination block 4, as shown in FIG. 13. For example, a DC voltage converter 2 stacks the small voltage of RF energy harvesting block 1 up to the necessary charging voltage for battery cell and charges a battery 3. Then, the battery 3 provides enough bias or power for the system (e.g., functional electronics 5) only when it needs to be working. In the current embodiment, a switched-capacitor DC voltage converter is used as the converter 2 for battery charging. This converter 2 and battery 3 combined block 4 bridges a gap between RF power harvesting block 1 and functional electronics 5, e.g., in insufficient RF power environments. So, it can help to implement a self-powered or stand alone system more effectively.

Usually, the developed battery cells have 1.1V˜1.2V built in potential after fabrication without any other charging or discharging steps, and slightly higher charging voltage than the built in potential was fine for battery recharging. Actually, charging voltage and time for constant voltage charging scheme show a trade-off relation. A 1.4 charging voltage of DC power supply is used during two hours for full recharging. FIG. 14 shows two types of batteries, a rigid battery (FIG. 14(a)), and a flexible battery (FIG. 14(b)).

Switched-Capacitor DC-DC Converter

There are two reasons why we choose a switched-capacitor scheme for DC-DC converter among several different types. The first is its simplicity of implementation, and the second is it needs capacitors for storing energy. The second factor is advantageous because the battery cells can be used as a capacitor also by some modifications. So the switched-capacitor method is a very attractive one.

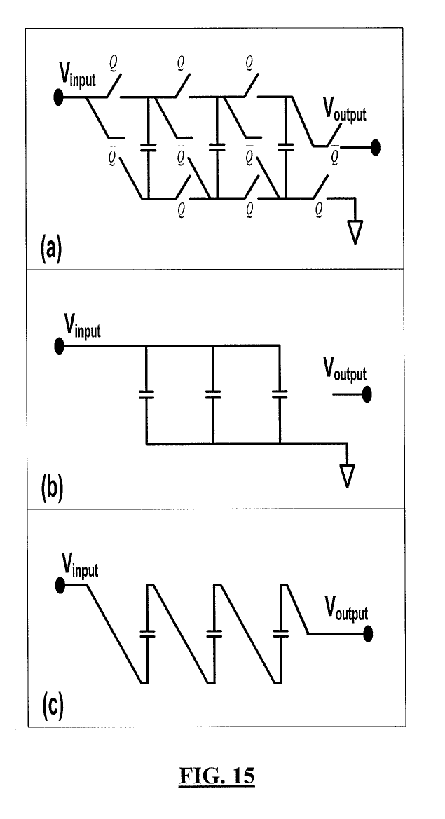

FIG. 15(a) shows the schematic of a switched capacitor DC-DC converter with three stages. A single chip is implemented using IBM8RF 0.13 um CMOS process including every switch for a five stage converter, except external capacitors. That is, maximum available output voltage is six times of input voltage through five external capacitors, and the output can be selected by a user from minimum (input×1) to maximum (input×6) just connecting an external capacitor's plus pad to input.

In the schematic, the top switches are made by nMOS only, but the middle and bottom switches are made by transmission gate, combining nMOS & pMOS to transfer the accumulated potential on each capacitor to the next stage without any loss. The converter works on two different phases. For capacitor storing phase (Q=1, Q̅=0 FIG. 15(b)), the input node is connected to every external capacitor, so all capacitors are in parallel. However, the output is disconnected from the converter. In this step, external capacitors are charged up through input. Then, during battery charging phase (Q=0, Q̅=1,

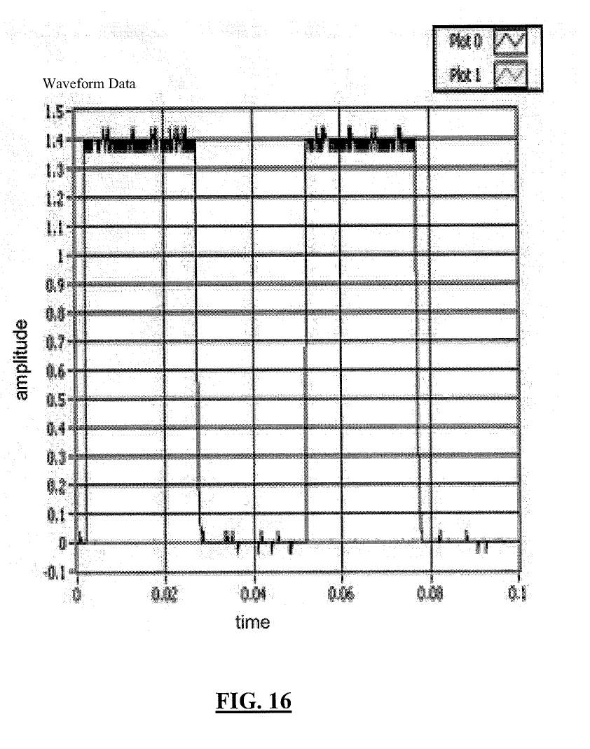

FIG. 15(c)), the parallel configuration of capacitors is changed into series, and the output is connected to the last capacitor's plus node. Note the input can be used in both phases without any waiting or sleeping mode. So, it can decrease the charging time by fully using the input source. FIG. 16 shows the output (˜1.4V) of the converter using a three stage converter for 0.35V input at 20 Hz clock signal using 100 uF three external capacitors. Note the body contacts of pMOS in converter switches are connected into external 1.5V DC power supply. This external source can be replaced with a battery for fully self-powered system implementation.

Big Capacitor Charging

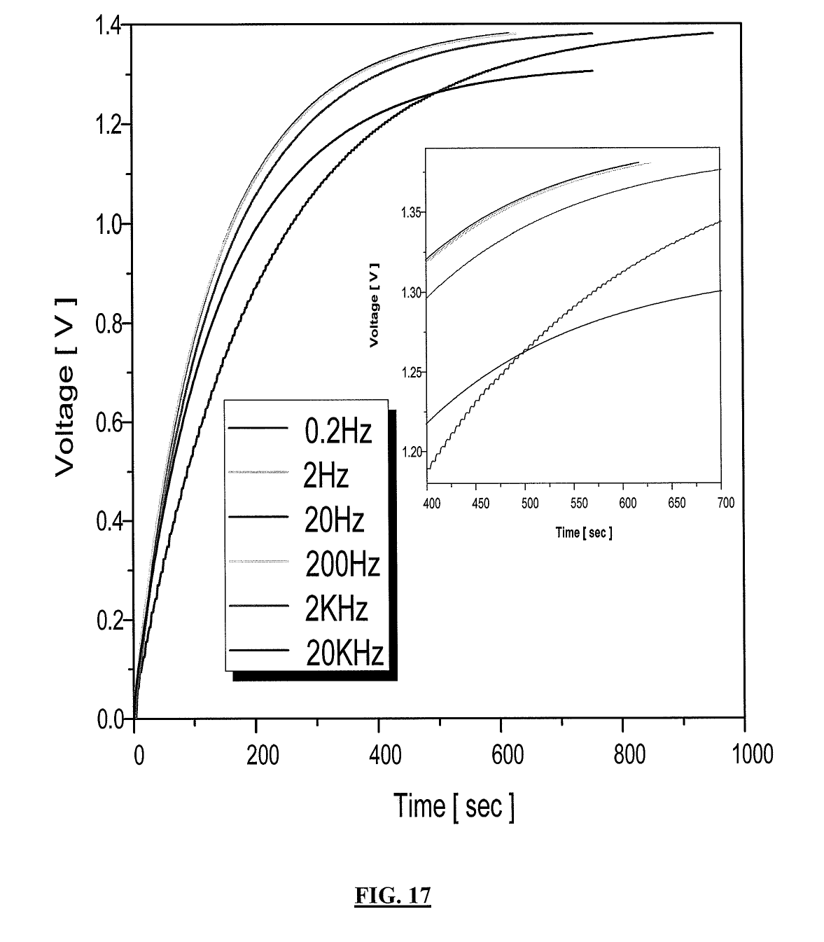

At the initial tests of the converter, a big capacitor, 1000 uF, replaces a battery for charging test to verify functionality of the converter, just using three stages. Also, frequency dependency is checked for different clock signals of 50% duty cycle. The external capacitors, storing energy from input voltage, and input voltage are fixed as 100 uF and 0.35V, respectively. FIG. 17 shows the results of capacitor charging for different clock signals, and the inner graph is a magnified version of 400˜700 sec section. All tests are stopped when the capacitor voltages reach 1.38V, except 20 KHz test. The plots for 2 Hz, 20 Hz, and 200 Hz test are almost overlapped. As listed in Table 1, 2 Hz and 20 Hz test have almost same results for energy transfer efficiency, around 40%, and charging time about 10 minutes, where the supplied energy is calculated by integrating the measured current from power supply and the stored energy is just calculated value using ½CV². As the clock frequency goes higher, the saturation voltage goes lower. It is caused by frequency dependency of dynamic power consumption of CMOS switches [6]. By frequency dependency tests, a 0.2 Hz˜20 Hz clock frequency range is used for battery charging tests.

TABLE 1
Frequency dependency of 1000 uF capacitor charging properties

| | | | | Energy |
|---|---|---|---|---|
| Clock | Charging | Supplied | Stored | Transfer |
| Frequency | Time | Energy | Energy | Efficiency |
| [Hz] | [sec] | [mJ] | [mJ] | [%] |
| 0.2 | 953.5 | 2.352 | 0.952 | 40.48 |
| 2 | 611.5 | 2.349 | 0.952 | 40.53 |
| 20 | 617.5 | 2.394 | 0.952 | 39.77 |
| 200 | 629.5 | 2.555 | 0.953 | 37.30 |
| 2K | 755.5 | 2.755 | 0.953 | 34.59 |
| 20K* | 755.5 | 3.010 | 0.852 | 28.31 |

*For 20 KHz test, 1.3 V saturated voltage is used for calculations.

Battery Charging

The test procedure follows three steps for battery charging: 1) initial discharging, 2) cell charging, and 3) discharging.

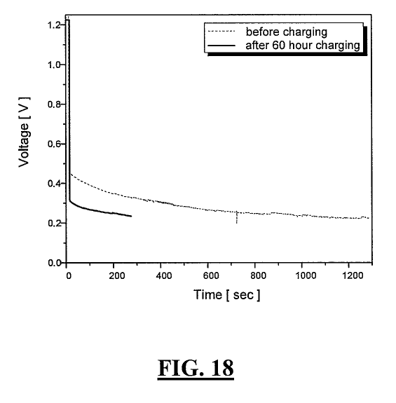

The first charging test set up is 0.3V input from power supply, five 100 uF external storing capacitors for a five stage converter, which provides 1.8V output without load, and 50% duty cycle 0.2 Hz clock signal. Actually, a test with 0.25V input, making 1.5V output by five stages, was performed, but the charging time took over several days. So, to reduce charging time, input voltage is increased from 0.25V to 0.3V. FIG. 18 shows the test results. After the initial discharging (dashed line) during 1280 seconds, the load voltage was dropped from 0.485V to 0.223V for 1 KΩ load resistor. The black solid line shows the discharging after 60 hours charging. 60 hours charging gives 0.316V initial load voltage, when 1 KΩ load is connected to the battery after charging. Though the charging time, 60 hours, is a little long, we demonstrate a DC-DC converter is working properly for the battery charging.

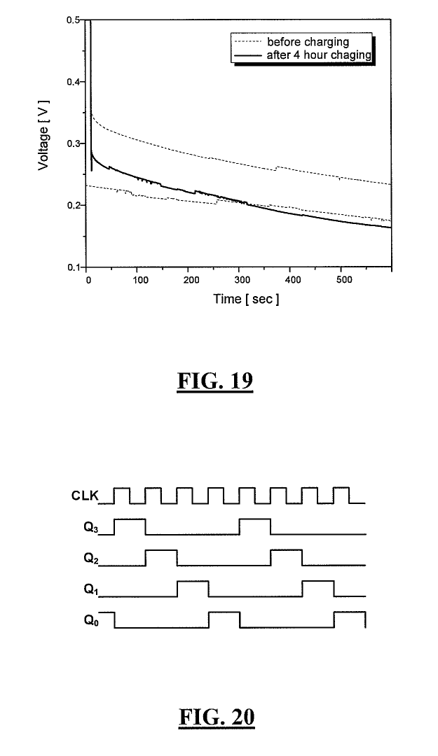

To reduce charging time, the input voltage is increased from 0.3V to 0.34V and two converters are used in parallel for another test. Clock signals are applied for two converters to operate in opposite mode at the same time. That is, if a converter is in capacitor storing mode, the other is in battery charging mode. The test setup is 0.34V input, generating 2V output without load due to using five stage, and 25 Hz clock signal with 50% duty cycle. The battery cell is discharged with 1 KΩ load during 20 minute before charging, as shown by the dashed line in FIG. 19, and load voltage drop is measured from 0.358V to 0.174V. Then, two converters charge the cell for 4 hours. This leads to 0.29V initial load voltage at discharging after charging (solid line in FIG. 19). Using higher input voltage and two converters, the charging time is effectively reduced from 60 hour to 4 hour.

Another charging test is performed using four converters for further decreasing charging time. To run four converters together, switching signals are generated using a ring counter, which is made by four D Flip-Flops. FIG. 20 shows the generated timing diagram of the counter, Q₀˜Q₃. Simply, inverters inverse each timing signal for the reverse switching signal inputs, Q̅₀˜ Q̅₃. Using the switching signals, if Q₀ is high, only one output of converters is connected to battery cell, and the others are in capacitor storing mode.

During capacitor storing mode, external capacitors are in parallel, so it gives a high total capacitance. Accordingly, it makes a long RC time constant for capacitor storing. Previous tests used five stages with 100 uF external capacitor, which gave 500 uF total capacitance for capacitor storing mode. For quick charging up capacitors, only three stages are used for other tests, which need three external capacitors for each converter. However, reducing the number of stage affects the output voltage directly. To compensate for this, higher input voltage is used. Also, higher input voltage can reduce the charging time further by providing more charges on storing capacitor, if the current capacity of the input signal is not limited. In the following tests, 0.35V, 0.4V, and 0.45V input are used for comparison.

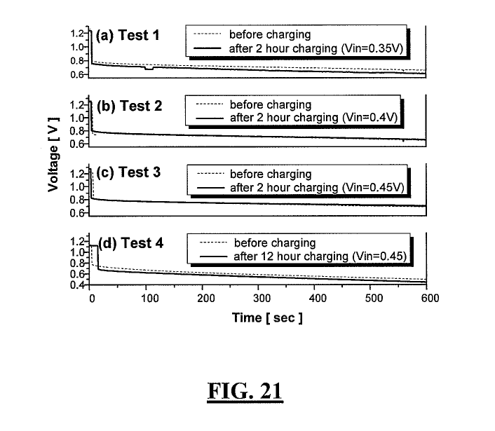

Four charging tests are performed using a rigid (Test 1˜3) and flexible (Test 4) type battery. For a rigid battery, charging time is limited to 2 hour, but the flexible cell is charged for 12 hours due to the cell's own property. Usually, the flexible battery consumed more current at the same charging voltage compared with rigid one. Furthermore, 9.85 KΩ and 100.2Ω load resistor are used at discharging for rigid and flexible battery, respectively. The test results and setup are shown in FIG. 21 and Table 2.

Every charging test shows energy recovery of battery. Although 2 hour charging with 0.35V input is not sufficient for full recovery before discharging, other two tests, Test 2 & 3, show the fully recovered battery potential compared with discharging before charging tests. However, Test 3 does not give any improvement in spite of higher input voltage, 0.45V. This may be due to the aging of the cell through several charging and discharging tests. Test 4 shows 12 hour charging result for flexible cell.

TABLE 2
Charging test setup and results

| | | | | | | Discharging during 10 minutes | | | | |
|---|---|---|---|---|---|---|---|---|---|---|
| | | | Charging | | | | Before | | After charging | |
| | | | (three stage converter) | | | | charging [V] | | [V] | |
| | | | | | Charging | Load | Initial | Final | Initial | Final |
| | Battery Cell | | Input | Clock | time | resistor | load | load | load | load |
| Test # | Type | Size | [V] | [Hz] | [Hour] | [Ω] | voltage | voltage | voltage | voltage |
| 1 | Rigid | 4 cm² | 0.35 | 20 | 2 | 9.85K | 0.804 | 0.659 | 0.759 | 0.612 |
| 2 | Rigid | 4 cm² | 0.4 | 20 | 2 | 9.85K | 0.790* | 0.648 | 0.804 | 0.659 |
| 3 | Rigid | 4 cm² | 0.45 | 20 | 2 | 9.85K | 0.818 | 0.688 | 0.828 | 0.701 |
| 4 | Flexible | 4 cm² | 0.45 | 2 | 12 | 100.2 | 0.775 | 0.497 | 0.689 | 0.445 |

*Initial load voltage for Test 3 before charging is estimated value because of a slacken load connection.

As described above with respect to FIGS. 13-21, a switched-capacitor DC-DC converter is implemented using a CMOS process for a battery cell charging application. Up to 40% energy transfer efficiency is obtained through capacitor charging tests. For battery cell charging tests, the functionality of the converter is verified for both rigid and flexible type battery cells using much smaller input voltage compared with general high charging voltage, more than 1.2V for the batteries discussed with respect to FIGS. 13-21.

The techniques described above show a dramatic increase in power harvesting efficiency as compared to existing RF Power Harvesting designs and, enable recharging portable wireless electric using ambient RF energy sources. Utilizing these improvements, a design goal of generating 1V output voltage with a greater than 20% RF to DC conversion efficiency from RF energy levels measured in the environment (66 uW) was met. This represents better than double the RF to DC conversion efficiency of the related art power matched RF energy harvesting circuit based on a Villard voltage doubler.

Several design improvements, novel to RF power harvesting circuits, have been disclosed. These improvement include RF to DC conversion efficiency through a reduction in the body effect of diode connected MOSFETs, reduction in the threshold voltage and by reducing the affects of circuit parasitics. These circuit improvements have been simulated to show a better than 60% improvement to RF to DC conversion efficiency.

While the present invention has been particularly shown and described with reference to exemplary embodiments thereof, it will be understood by one of ordinary skill in the art that various changes in form and details may be made therein without departing from the spirit and scope of the present invention as defined by the following claims.

1. An RF power harvesting device comprising:
an inductor;
a first capacitor connected to the inductor;
a first MOSFET connected to a first node, and
a second MOSFET connected to the first node,
wherein the inductor or the first capacitor are connected to the first node.

2. The RF power harvesting device of claim 1, wherein values of the first MOSFET and the second MOSFET are such that intrinsic capacitances of the first MOSFET and the second MOSFET and the inductor constitute a substantially resonant circuit during operation of the RF power harvesting device.

3. The RF power harvesting device of claim 1, further comprising:
a second capacitor connected to a second node, and the second MOSFET is connected to the second node,
wherein the second MOSFET is a PMOSFET.

4. The RF power harvesting device of claim 1, further comprising:
a receiver which detects and receives ambient RF energy,
wherein the first capacitor and the receiver are connected at a third node, the first capacitor and the inductor are connected in series at a fourth node, and the inductor is connected to the first node.

5. The RF power harvesting device of claim 1, further comprising:
a first set of resisting elements connected to a first gate of the first MOSFET to apply a first DC bias to the first gate; and
a second set of resisting elements connected to a second gate of the second MOSFET to apply a second DC bias to the second gate.

6. A receiver comprising:
an impedance matching circuit connected to a first node;
a first MOSFET connected to the first node; and
a second MOSFET connected to the first node, wherein
the first MOSFET is a diode-connected p type MOSFET.

7. The receiver of claim 6, wherein the impedance matching circuit comprises an inductor and a capacitor in series, the inductor connected to the first node.

8. The receiver of claim 6, wherein a resistive biasing network provides a bias voltage to gate terminals of the first MOSFET and the second MOSFET.

9. A system comprising:
a receiver;
a voltage converter; and
an energy storage device, wherein
the receiver is configured to receive a high frequency signal and supply a first voltage to the voltage converter, and
the voltage converter is configured to amplify the first voltage supplied by the receiver and supply the amplified voltage to the energy storage device.

10. The system of claim 9, wherein the voltage converter includes a switched capacitor circuit.
